(19) United States
(12) Patent Application Publication
(10) Pub. No.: US 2023/0410795 A1
(43) Pub. Date: Dec. 21, 2023

(54) INFORMATION PROCESSING DEVICE

(71) Applicant: NTT DOCOMO, INC., Chiyoda-ku (JP)

(72) Inventors: Mariko CHIBA, Chiyoda-ku (JP); Junya TAKIUE, Chiyoda-ku (JP); Sae IIJIMA, Chiyoda-ku (JP); Taichi KATAYAMA, Chiyoda-ku (JP); Kei KIKUIRI, Chiyoda-ku (JP)

(73) Assignee: NTT DOCOMO, INC., Chiyoda-ku (JP)

(21) Appl. No.: 18/251,765

(22) PCT Filed: Dec. 8, 2021
(86) PCT No.: PCT/JP2021/045144

§ 371 Date: May 4, 2023

(30) Foreign Application Priority Data
Jan. 5, 2021 (JP) 2021-000552

(51) Int. Cl. G10L 15/08

(52) U.S. Cl. CPC G10L 15/08; G10L 2015/088

(57) ABSTRACT

The related information presentation server 10 includes an acquisition unit 12 configured to acquire presentation information indicating lecture content by a lecturer, a detection unit 13 configured to detect a pre-registered keyword included in the presentation information acquired by the acquisition unit 12, and a presentation unit 14 configured to present related information related to the keyword detected by the detection unit 13 to a student. The presentation unit 14 is configured to determine a frequency of presenting the related information to the student based on at least one of a knowledge level of the student regarding the presentation content and a degree of difficulty of the keyword, and present the related information to the student in accordance with the determined frequency.

### TECHNICAL FIELD

One aspect of the present invention relates to an information processing device.

### BACKGROUND ART

Conventionally, in order to improve the convenience of voice chat users, a system is known in which voice chat conversation content is acquired, keywords registered in advance are extracted from the voice data of the conversation content, and related information of the extracted keywords (search results obtained by information search using the keywords and articles related to the keywords) is presented to the voice chat users (see Patent Document 1).

### CITATION LIST

### Patent Document

[Patent Document 1] Japanese Unexamined Patent Publication No. 2008-287697

### SUMMARY OF INVENTION

### Technical Problem

For example, in an online lecture system or the like, it is considered that the convenience of a viewer (e.g., a student) is improved by presenting related information of a keyword included in presentation content of a presenter (e.g., a lecturer) to the viewer using the above-described system. However, if the related information of a keyword is presented to the viewer every time the keyword is detected, the viewer may feel annoyed.

An object of one aspect of the present invention is to provide an information processing device capable of further improving the convenience of a viewer.

### Solution to Problem

An information processing device according to one aspect of the present invention includes: an acquisition unit configured to acquire presentation information indicating presentation content presented by a presenter; a detection unit configured to detect a pre-registered keyword included in the presentation information acquired by the acquisition unit; and a presentation unit configured to present related information related to the keyword detected by the detection unit to a viewer. The presentation unit is configured to determine a frequency of presenting the related information to the viewer based on at least one of a knowledge level of the viewer regarding the presentation content and a degree of difficulty of the keyword, and present the related information to the viewer in accordance with the determined frequency.

According to an aspect of the present invention, it is possible to effectively improve understanding of the viewer with respect to the presentation content by presenting the related information of a keyword included in the presentation content presented by the presenter to the viewer. Furthermore, since the frequency of presenting the related information to the viewer is adjusted based on at least one of the knowledge level of the viewer and the degree of difficulty of the keyword, it is possible to effectively present the related information to the viewer at an appropriate frequency in accordance with the viewer or the keyword. Therefore, the convenience of the viewer can be further improved.

### Advantageous Effects of Invention

According to one aspect of the present invention, it is possible to provide an information processing device capable of further improving the convenience of a viewer.

### BRIEF DESCRIPTION OF DRAWINGS

FIG. 1 is a diagram illustrating an overall configuration of an online lecture system according to an embodiment.

FIG. 2 is a diagram illustrating an example of a functional configuration of a related information presentation server.

FIG. 3 is a diagram illustrating an example of keyword information stored in the keyword DB.

FIG. 4 is a diagram illustrating an example of presentation history stored in the presentation history DB.

FIG. 5 is a diagram illustrating an example of a lecture screen presented to a student.

FIG. 6 is a diagram illustrating a first modification example of related information.

FIG. 7 is a diagram illustrating a second modification example and a third modification example of related information.

FIG. 8 is a diagram used to describe a process of setting a knowledge level of student.

FIG. 9 is a flowchart showing an example of the operation of the related information presentation server.

FIG. 10 is a diagram showing an overall configuration of an online lecture system according to a modification.

FIG. 11 is a diagram illustrating an example of a hardware configuration of the related information presentation server.

### DESCRIPTION OF EMBODIMENTS

Hereinafter, an embodiment of the present invention will be described in detail with reference to the accompanying drawings. In the description of the drawings, the same or corresponding elements will be denoted by the same reference signs, and redundant description will be omitted.

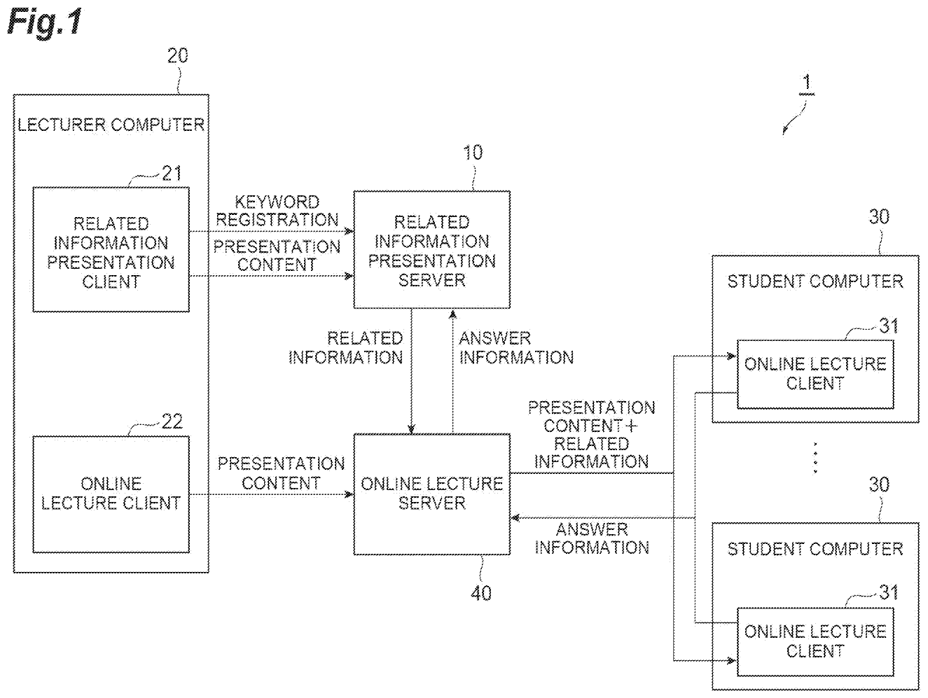

FIG. 1 is a diagram illustrating an overall configuration of an online lecture system 1 according to an embodiment. The online lecture system 1 includes a related information presentation server 10 (information processing device), a lecturer computer 20, a plurality of student computers 30, and an online lecture server 40. In the present embodiment, as an example, a case where online lecture related to the Western philosophy is performed using the online lecture system 1 will be described.

The lecturer computer 20 is a computer device used by a presenter of the online lecture. The lecturer computer 20 is, for example, a desktop PC, a laptop PC, or the like. The lecturer computer 20 includes a related information presentation client 21 that is a program for performing data communication with the related information presentation server 10, and an online lecture client 22 that is a program for performing data communication with the online lecture server 40.

The student computers 30 are computer devices used by students (viewers) of the online lecture. The student computer 30 is, for example, a desktop PC, a laptop PC, or the like. The student computer includes an online lecture client 31 that is a program for performing data communication with the online lecture server 40.

The online lecture server 40 has a function of receiving presentation information indicating lecture content (presentation content) from the online lecture client 22 of the lecturer computer 20 and distributing the received presentation information to the online lecture client 31 of each student computer 30. The online lecture server 40 is configured by one or more computer devices. The presentation information may include, for example, a voice data of the lecturer input to the lecturer computer 20, an image (video) data indicating the content of lecture material (lecture slide or the like) displayed and operated on the lecturer computer 20, and the like.

The related information presentation server 10 is a server device that executes processing in relation to presentation of related information (described in detail later). The related information presentation server 10 is configured by one or more computer devices. The related information presentation server 10 accepts keyword registration via the related information presentation client 21 of the lecturer computer 20 in pre-processing performed before the start of the online lecture. The keyword registration process will be described in detail later. During the online lecture, the related information presentation server 10 receives presentation information from the related information presentation client 21 of the lecturer computer 20 in accordance with the progress of the online lecture. The related information presentation server 10 detects a keyword included in the received presentation information, generates related information related to the detected keyword, and transmits the generated related information to the online lecture server 40. Upon receiving the related information from the related information presentation server 10, the online lecture server 40 delivers the received related information to the online lecture client 31 of each student computer 30. By the above-described processing, each student can refer to the related information of the keyword that appears during the lecture together with lecture content (for example, a voice of the lecturer and an image of a lecture slide) on the student computer 30. That is, it is possible to enhance the convenience of the student by presenting the related information that helps the student understand the lecture content. When the related information distributed to the student computer 30 includes a question such as a quiz or a questionnaire asking for an answer from the student, the online lecture client 31 acquires answer information input by the student and transmits the answer information to the online lecture server 40.

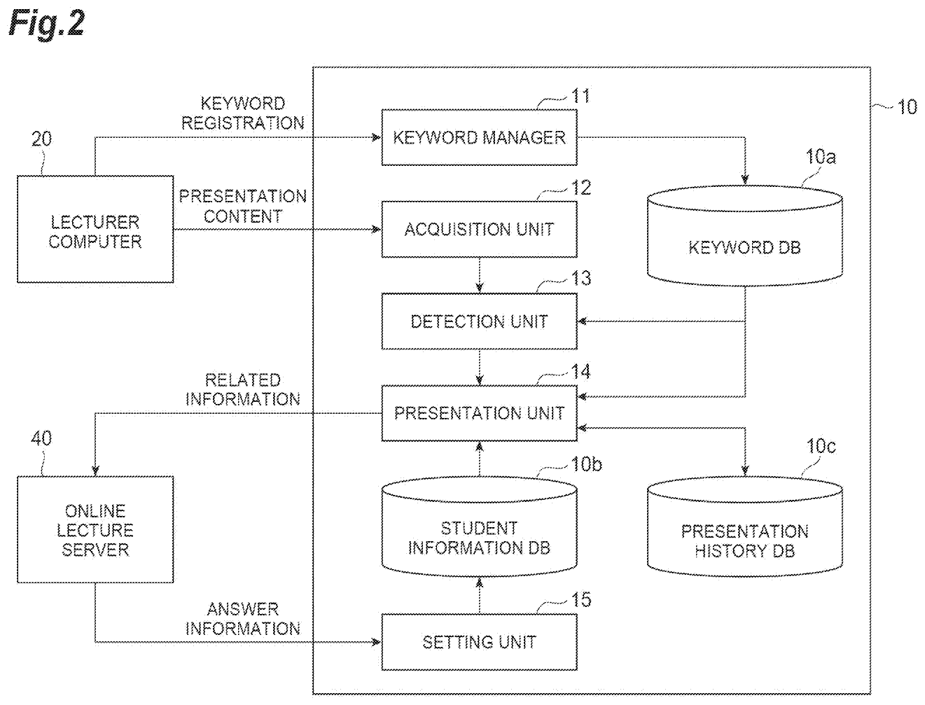

FIG. 2 is a diagram illustrating an example of a functional configuration of the related information presentation server 10. As illustrated in FIG. 2, the related information presentation server 10 includes a keyword manager 11, an acquisition unit 12, a detection unit 13, a presentation unit 14, and a setting unit 15 as functional components. The related information presentation server 10 includes a keyword DB 10a, a student information DB 10b, and a presentation history DB 10c, which are storage units (data bases) that store various data.

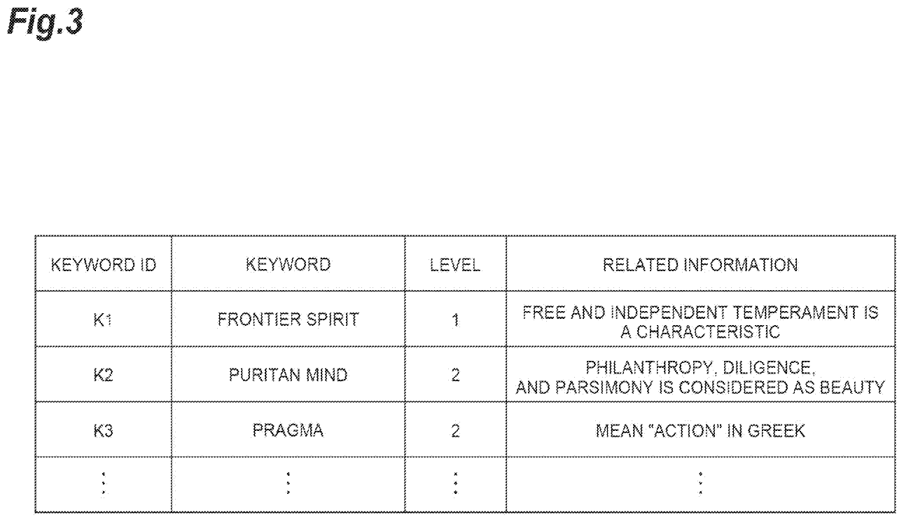

The keyword manager 11 registers and sets keyword information in the keyword DB 10a. FIG. 3 shows an example of the keyword information. As illustrated in FIG. 3, the keyword information is information in which a keyword ID, a keyword, a level, and related information are associated with each other. As an example, the keyword information is pre-registered by the lecturer. For example, when the lecturer operates the lecturer computer 20 to input a keyword to be registered, information instructing registration of the keyword is transmitted from the related information presentation client 21 to the related information presentation server 10. In response to the reception of the information, the keyword manager 11 generates keyword information related to the received keyword and registers it in the keyword DB 10a.

The “keyword ID” is identification information for uniquely specifying a keyword, and is automatically numbered in the order of registration, for example. The “keyword” is typically a technical term such as “frontier spirit”, “puritan mind”, “pragma” and the like. However, the keyword is not limited to the technical term as described above, and any word may be registered as the keyword. The “level” is information indicating the degree of difficulty of the keyword (an index such as difficulty in understanding or novelty). In the present embodiment, as an example, three levels of “Level 1 (basic)”, “Level 2 (intermediate level)”, and “Level 3 (advanced level)” are prepared as levels of keywords. However, the level of the keyword may be a step value (discrete value) of two steps or four steps or more, or may be represented by an arbitrary numerical value (a value indicating that the larger the value is, the more difficult it is). The “related information” is information related to a keyword. Examples of the related information include an annotation (explanatory text) related to the keyword, a link (for example, URL or the like) to information related to the keyword (for example, website or the like), a question (quiz, questionnaire or the like) related to the keyword, and the like.

The keyword manager 11 may set the level of each keyword by executing the following processing, for example.

As a first example, the level of the keyword may be manually input at the time of keyword registration (in the present embodiment, operation of the lecturer computer 20 by the lecturer). For example, the level of each keyword may be determined by the lecturer who is familiar with the keyword. In this case, the keyword manager 11 may set the level input at the time of the keyword registration as the level of the keyword.

As a second example, the level of the keyword may be automatically set without human intervention by using a technique such as tf-idf (Term Frequency-Inverse Document Frequency). For example, the keyword manager 11 may calculate the importance of the keyword based on the term frequency (TF value) of the keyword in the document used for the lecture (presentation) by the lecturer and the inverse document frequency (IDF value) of the keyword in a plurality of documents related to the field to which the keyword belongs, and set the degree of difficulty of the keyword based on the calculated importance. Hereinafter, the processing of the above second example will be described in detail.

For example, the keyword manager 11 calculates a TF value which is an appearance frequency of a keyword in a document (for example, lecture material such as a lecture slide) used for a lecture by using the following Equation (1). In the following Equation (1), “d” represents a document used for presentation, and “t” represents a keyword. “tf (t, d)” indicates the TF value of the keyword t in the document d. “n_{t, d}” indicates the number of appearances of the keyword t in the document d. “Σ_{s∈d} n_{s, d}” indicates the sum of the number of appearances of all keywords in the document d.

tf(t,d)=n_{t,d}/Σ_{s∈d}n_{s,d} (1)

In addition, the keyword manager 11 calculates an IDF value which is an inverse document frequency of the keyword in a plurality of documents (in the present embodiment, a plurality of documents related to the Western philosophy) related to a field (domain) to which the keyword belongs based on the following Equation (2). In the following Equation (2), “idf (t)” represents an IDF value of the keyword t. “N” indicates the total number of prepared documents. “df (t)” indicates the number of documents in which the keyword t appears.

idf(t)=log{N/df(t)}+1 (2)

For example, the keyword manager 11 multiplies the TF value and the IDF value of the keyword t calculated as described above to obtain a TF-IDF value of the keyword t. Here, the TF-IDF value becomes larger for a keyword that characterizes a document used for presentation and has a lower appearance frequency in other documents. In other words, a keyword that is not common in a field related to the keyword (for example, a professional and difficult term related to lecture content) has a larger TF-IDF value. That is, the TF-IDF value is an index indicating the degree of importance of the keyword in the lecture content and indicating the degree of difficulty (degree of novelty) of the keyword. Therefore, the keyword manager 11 may set the level of the keyword based on the TF-IDF value of the keyword.

For example, the keyword manager 11 may prepare several threshold values in advance and set the level of the keyword by comparing the TF-IDF value with the threshold value. For example, the keyword manager 11 may set the level of the keyword to “Level 3 (advanced)” when the TF-IDF value of the keyword is equal to or greater than the first threshold (e.g., “0.07”), set the level of the keyword to “Level 2 (intermediate)” when the TF-IDF value of the keyword is equal to or greater than the second threshold (e.g., “0.03”) and less than the first threshold, and set the level of the keyword to “Level 1 (beginner)” when the TF-IDF value of the keyword is less than the second threshold. By executing the above processing for each keyword, the level of each keyword is set.

According to the process of the keyword manager 11 in the second example described above, the level of the keyword can be appropriately set based on the TF-IDF value (importance) of the keyword. In addition, as described above, since the level of the keyword can be automatically set by predetermined processing (for example, calculation of Equations (1) and (2), comparison determination between the TF-IDF value and the threshold value, or the like), it is possible to reduce time and effort when manually setting the level of the keyword.

The keyword manager 11 sets related information of each keyword by executing, for example, the following processing. As a first example, the related information of the keyword may be manually input at the time of the keyword registration (in the present embodiment, operation of the lecturer computer 20 by the lecturer). For example, a lecturer who is familiar with the keyword may input the related information of each keyword. In this case, the keyword manager 11 may set the related information input at the time of the keyword registration as related information of the keyword as it is. As a second example, the keyword manager 11 may refer to an external lexical data base or the like in which lexical information is stored, and set an explanatory text (annotation) corresponding to the keyword described in the lexical data base as related information of the keyword. In addition, by referring to a data base or the like in which a link to information regarding the keyword, a question regarding the keyword, or the like is registered in advance, the keyword manager 11 may set the link, the question, or the like associated with the keyword as related information of the keyword.

By the registration processing by the keyword manager 11 described above, the keyword information (see FIG. 3) of each keyword included in the lecture content is stored in the keyword DB 10a in advance before the online lecture starts.

The acquisition unit 12 acquires the presentation information indicating lecture content of the lecturer. The acquisition unit 12 acquires the presentation information in accordance with the progress of the presentation (online lecture in the present embodiment) presented by the lecturer. For example, the acquisition unit 12 acquires a voice uttered by the lecturer (that is, a voice data of the lecturer input to the lecturer computer 20) as the presentation information. In addition, the acquisition unit 12 may acquire, as the presentation information, text information included in a lecture slide page (i.e., a screen delivered to the online lecture client 31 of each student computer 30 through the online lecture client 22 and the online lecture server 40) opened by the lecturer on the lecturer computer 20 for explanation.

The detection unit 13 detects a previously registered keyword included in the presentation information acquired by the acquisition unit 12. In the present embodiment, the detection unit 13 detects a keyword when the presentation information includes the keyword by referring to the keyword DB10a. When the presentation information is acquired as the voice data, the detection unit 13 may convert the voice data into text information by performing, for example, known voice recognition processing, and detect a keyword included in the presentation information by determining whether or not a character string corresponding to the keyword is included in the text information.

The presentation unit 14 presents the related information related to the keyword detected by the detection unit 13 to the student. In the present embodiment, the presentation unit 14 presents the related information to students via the online lecture server 40 and the student computer 30. More specifically, the presentation unit 14 transmits the related information to the online lecture client 31 of the student computer 30 via the online lecture server 40. Then, the presentation unit 14 causes the online lecture client 31 to display the related information on the screen of the student computer 30.

The presentation unit 14 determines the frequency of presenting the related information to the student based on at least one of the knowledge level of the student regarding the lecture content and the level (a degree of difficulty) of the keyword, and presents the related information to the student in accordance with the determined frequency. Here, when the frequency is determined based on only the level of the keyword, the frequency of presenting the related information of a certain keyword is the same among all students. On the other hand, when the frequency is determined based on at least the knowledge level of student (when the frequency is determined based on only the knowledge level of student, or when the frequency is determined based on both the knowledge level of student and the level of keyword), the frequency of presenting the related information of a certain keyword is determined for each student (for each student group classified into the same knowledge level). In the present embodiment, the presentation unit 14 determines the frequency based on a combination of the knowledge level of student and the level of keyword.

The knowledge level of each student is registered in advance in the student information DB 10b. In the present embodiment, as an example, three levels corresponding to the level of understanding for keywords are prepared as knowledge levels. Specifically, a beginner level indicating that the degree of understanding for keywords of Level 1 is equal to or greater than a certain level, an intermediate level indicating that the degree of understanding for keywords of Level 1 and Level 2 is equal to or greater than a certain level, and an advanced level indicating that the degree of understanding for keywords of Level 1 to Level 3 is equal to or greater than a certain level are prepared as knowledge levels.

The knowledge level of each student may be set based on, for example, a test performed in advance to confirm the knowledge level of each student, a questionnaire result, or the like. Note that the knowledge level of student whose knowledge level is unknown may be set to a default value (for example, beginner level). The knowledge level of the student registered in the student information DB 10b may be updated as appropriate. In the present embodiment, the knowledge level of each student is appropriately set (updated) by the setting unit 15 described later.

The type of the frequency of presenting related information of a certain keyword includes a case where the related information is not presented. In the present embodiment, the frequency of presenting related information of a keyword may include at least two of a first frequency (presented each time) indicating that the related information is presented each (every) time the keyword appears, a second frequency (reminder presentation) indicating that the related information is not presented even if the keyword appears again within a predetermined period (for example, five minutes) from the last presentation of the related information of the keyword, a third frequency (presented for first time only) indicating that the related information is presented only when the keyword appears first, and a fourth frequency (no presentation) indicating that the related information is not presented at all. In the present embodiment, as an example, all of the first frequency to the fourth frequency are used. The frequency decreases in the order of first frequency, second frequency, third frequency, and fourth frequency. That is, among the first frequency to the fourth frequency, the first frequency (presented each time) has the highest frequency and the fourth frequency (no presentation) has the lowest frequency.

As described above, in the present embodiment, the presentation unit 14 determines the frequency based on both the level of the keyword and the knowledge level of the student. In other words, the frequency is determined for each combination of keyword and student. For example, the presentation unit 14 determines the frequency so that the frequency is higher as the knowledge level of the student is lower. In addition, the presentation unit 14 determines the frequency so that the frequency is higher as the level of the keyword is higher. As an example, the presentation unit 14 determines the frequency based on a predetermined Determination Rule as follows.

<Determination Rule>

For the student of the beginner level, the frequency of presenting the related information of the keyword of Level 1 is determined to be the third frequency (presented for first time only), the frequency of presenting the related information of the keyword of Level 2 is determined to be the second frequency (reminder presentation), and the frequency of presenting the related information of the keyword of Level 3 is determined to be the first frequency (presented each time).

For the student of the intermediate level, the frequency of presenting the related information of the keyword of Level 1 is determined as the fourth frequency (no presentation), the frequency of presenting the related information of the keyword of Level 2 is determined as the third frequency (presented for first time only), and the frequency of presenting the related information of the keyword of Level 3 is determined as the second frequency (reminder presentation).

For the student of the advanced level, the frequency of presenting the related information of the keywords of Level 1 and Level 2 is determined to be the fourth frequency (no presentation), and the frequency of presenting the related information of the keyword of Level 3 is determined to be the third frequency (presented for first time only).

By making the frequency higher as the knowledge level of the student is lower, it is possible to sufficiently present the related information (annotation or the like) of the keyword to the student having a small amount of knowledge about the lecture content (for example, the student of the beginner level) and to improve understanding for the lecture of the student. On the other hand, for a student having a sufficient amount of knowledge about the lecture content (for example, a student of the advanced level), by setting the frequency of presenting the related information to be relatively low, it is possible to prevent the student from feeling annoyed by the related information of a keyword already known by the student being presented frequently.

By making the frequency higher as the level (degree of difficulty) of the keyword is higher, it is possible to sufficiently present the related information (annotation or the like) of the keyword such as a difficult technical term, an uncommon (rare) term, or the like to the student and improve understanding for the lecture of the student. On the other hand, by setting the presentation frequency to be low for the related information of a relatively easy keyword, it is possible to prevent the student from feeling annoyed by the related information of a keyword already understood by the student being presented frequently.

In addition, by determining the frequency based on the combination of the knowledge level of the student and the level of the keyword as in the present embodiment, it is possible to obtain both the effects described above. That is, the related information can be presented to the student more effectively in accordance with the knowledge level of the student and the level of the keyword.

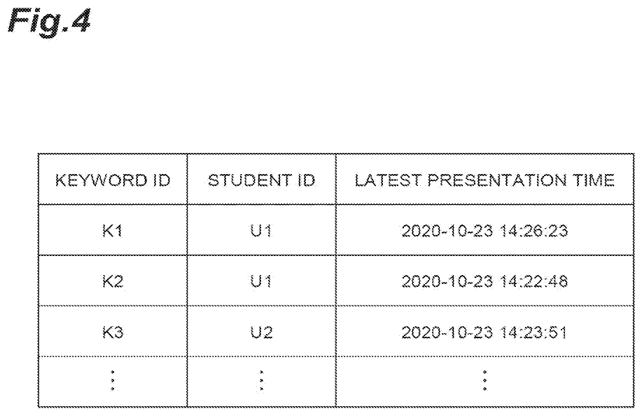

In order to realize presentation of the related information according to the second frequency (reminder presentation) or the third frequency (presented for first time only) described above, the presentation unit 14 stores a presentation history indicating the latest presentation time at which the related information of a keyword is presented to a student for each combination of a student and a keyword. In the present embodiment, each time related information of a certain keyword is presented to a certain student, the presentation unit 14 stores a presentation history related to the presentation in a presentation history DB 10c. FIG. 4 is a diagram illustrating an example of presentation history stored in the presentation history DB 10c. The presentation history in the first row in the example of FIG. 4 indicates that related information of the keyword specified by the keyword ID “Kl” is presented to the student specified by the student ID “U1” (that is, the student computer 30 of the student) at “14:26:23 on Oct. 23, 2020”. Although the presentation history is stored for each combination of student and keyword as an example in the present embodiment, the presentation history may be stored for each combination of knowledge level of student and keyword when users of the same knowledge level are equally handled.

When the presentation frequency of a certain keyword Y with respect to a certain student X is determined as the second frequency (reminder presentation) based on the above-described determination rule, the presentation unit 14 determines whether a presentation history corresponding to a combination of student ID of the student X and keyword ID of the keyword Y is stored in the presentation history DB 10c. When the presentation history is stored in the presentation history DB 10c, the presentation unit 14 determines whether or not a predetermined period (for example, 5 minutes) or more has elapsed from the latest presentation time indicated by the presentation history. When the predetermined period or more has elapsed from the latest presentation time, the presentation unit 14 presents the related information of the keyword Y to the student X. On the other hand, when the predetermined period or more has not elapsed from the latest presentation time, the presentation unit 14 does not present the related information of the keyword Y to the student X.

In addition, when the presentation frequency of a certain keyword Y with respect to a certain student X is determined as the third frequency (presented for first time only) based on the above-described determination rule, the presentation unit 14 determines whether or not a presentation history corresponding to a combination of student ID of the student X and keyword ID of the keyword Y is stored in the presentation history DB 10c. When the presentation history is not stored in the presentation history DB 10c, the presentation unit 14 presents the related information of the keyword Y to the student X. On the other hand, when the presentation history is stored in the presentation history DB 10c, the presentation unit 14 does not present the related information of the keyword Y to the student X.

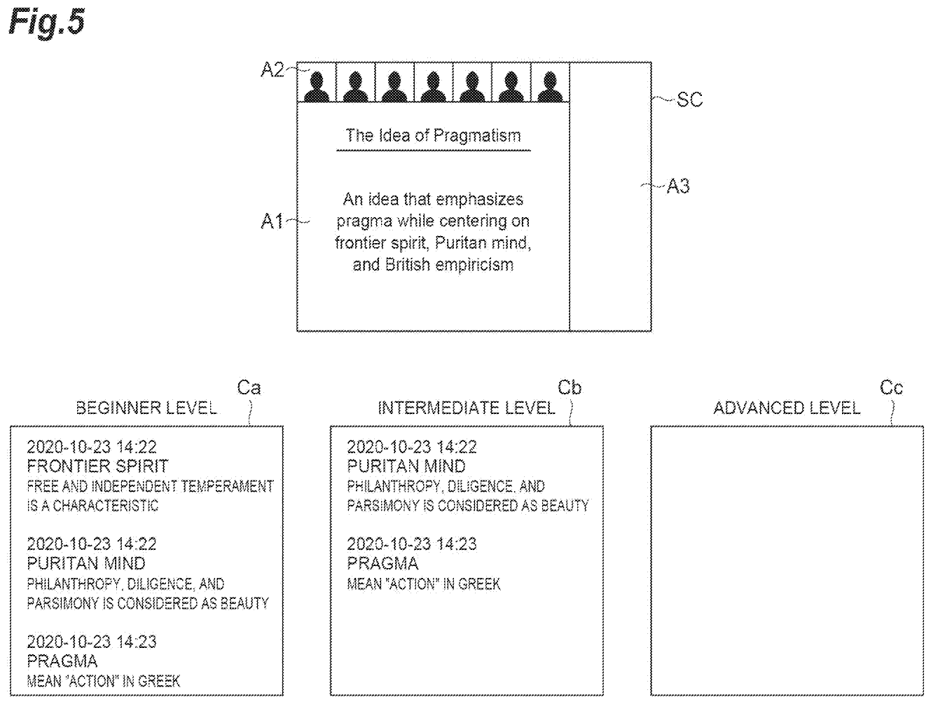

FIG. 5 is a diagram showing an example of a lecture screen presented to the student (i.e., a screen displayed on the display of the student computer 30). In the example of FIG. 5, the lecture screen SC includes a first display area A1, a second display area A2, and a third display area A3. The first display area A1 is a screen area for displaying lecture material (for example, a lecture slide opened by the lecturer on the lecturer computer 20). The second display area A2 is a screen area for displaying a camera image (for example, an image in which each student appears) captured by a camera included in each student computer 30. The third display area A3 is a screen area for displaying the related information. The third display area A3 may be an area for displaying a chat performed between the lecturer and each student, for example. That is, a chat screen for displaying a chat may be used as the third display area A3.

The beginner level screen Ca is displayed in the third display area A3 of the lecture screen SC of the student computer 30 of the student whose knowledge level is the beginner level. In the beginner level screen Ca, the related information of the keyword determined to be presented by the presentation unit 14 based on the above-described determination rule (that is, the frequency determined based on the determination rule applied to the student of the beginner level) is displayed. In this example, the related information of all keywords detected by the detection unit 13 (i.e., “Frontier spirit” of Level 1 and “Puritan mind” and “Pragma” of Level 2) is displayed based on the above-described determination rule applied to the student of the beginner level.

The intermediate level screen Cb is displayed in the third display area A3 of the lecture screen SC of the student computer 30 of the student whose knowledge level is the intermediate level. In the intermediate level screen Cb, the related information of the keyword determined to be presented by the presentation unit 14 based on the above-described determination rule (that is, the frequency determined based on the determination rule applied to the student of the intermediate level) is displayed. In this example, only the related information of “Puritan mind” and “Pragma” of Level 2 among all the keywords detected by the detection unit 13 is displayed based on the above-described determination rule applied to the student of the intermediate level.

The advanced level screen Cc is displayed in the third display area A3 of the lecture screen SC of the student computer 30 of the student whose knowledge level is the advanced level. In the advanced level screen Cc, the related information of the keyword determined to be presented by the presentation unit 14 based on the above-described determination rule (that is, the frequency determined based on the determination rule applied to the student of the advanced level) is displayed. In this example, since the keyword of the Level 3 is not included in all the keywords detected by the detection unit 13, no related information of any keyword is displayed in the advanced level screen Cc.

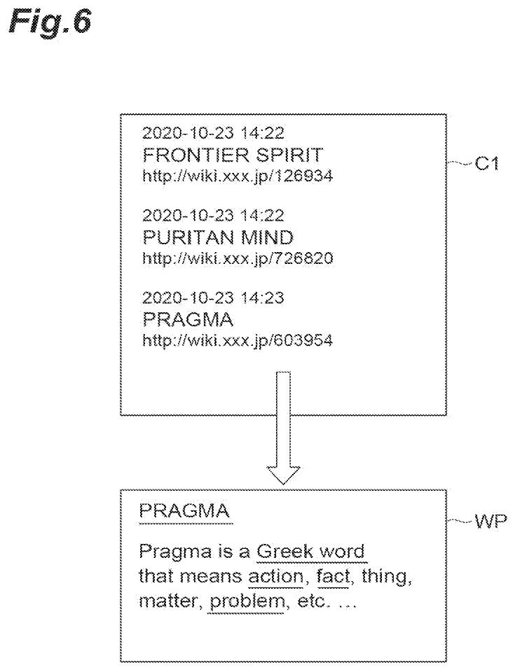

The related information displayed in the third display area A3 is not limited to the example illustrated in FIG. 5 (that is, a case where a description (annotation) of a keyword is presented as related information). FIG. 6 is a diagram illustrating a first modification example of related information (here, a screen displayed in the third display area A3) presented to a student. As shown in FIG. 6, the third display area A3 may display a screen C1 including, as related information, a link (URL) to the webpage WP in which detailed information about a keyword is described. For example, when a link included in the screen C1 is clicked, the screen of the webpage WP associated with the link may be opened in the same window (third display area A3) or in a different window (a screen different from the third display area A3).

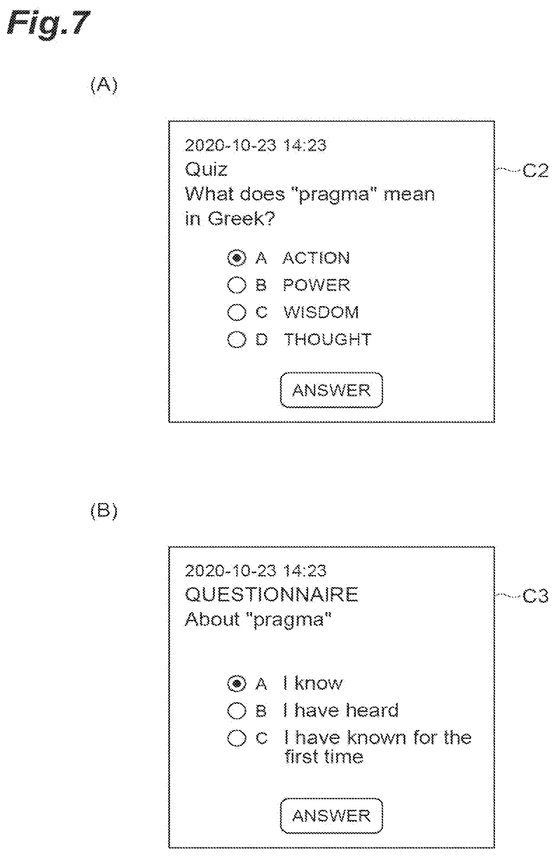

As shown in (A) and (B) of FIG. 7, the related information may include a question for measuring understanding of a student about a keyword.

(A) of FIG. 7 is a diagram illustrating a second modification example of related information (a screen displayed in the third display area A3) presented to a student. As illustrated in (A) of FIG. 7, a screen C2 including a quiz (question) related to a keyword (“Pragma” in this example) may be displayed in the third display area A3. For example, when the student checks an option considered to be correct among the options (four options A to D in this example) displayed on the screen C2 and clicks an “Answer” button, answer information indicating the answer is transmitted from the online lecture client 31 of the student computer 30 to the related information presentation server 10 via the online lecture server 40.

(B) of FIG. 7 is a diagram illustrating a third modification example of related information (a screen displayed in a third display area A3) presented to a student. As illustrated in (B) of FIG. 7, a screen C3 including a questionnaire (question) related to a keyword (“Pragma” in this example) may be displayed in the third display area A3. For example, when the student checks an option applicable to him/her among the options (three options A to C in this example) regarding understanding displayed on the screen C3 and clicks an “Answer” button, answer information indicating the answer is transmitted from the online lecture client 31 of the student computer 30 to the related information presentation server 10 via the online lecture server 40.

The answer information of each student may be fed back to the lecturer. For example, the related information presentation server 10 may transmit the answer information of each student received from each student computer 30 to the lecturer computer 20. The lecturer computer may display the received answer information of each student on a display of the lecturer computer 20. For example, the lecturer computer 20 may display the aggregation result of the answer information of each student on the display of the lecturer computer 20. For example, based on the answer information of each student with respect to the questionnaire shown in (B) of FIG. 7, the lecturer computer 20 may calculate the number of users who have answered “A: I know”, the number of users who have answered “B: I have heard”, and the number of users who have answered “C: I have known for the first time”, and display the number of answers, the ratio, and the like on the display of the lecturer computer 20. According to the above configuration, the lecturer can flexibly adjust lecture content based on the answer result of each student. For example, in the questionnaire shown in (B) of FIG. 7, when the number of users who have answered “C: I have known for the first time” is large, the lecturer can explain the term “Pragma” based on the answer result. On the other hand, in a case where the number of users who have answered that “A: I know” is large, the lecturer can omit the explanation of the term “Pragma” based on the answer result.

When the related information includes a question for measuring understanding of a student about a keyword (for example, (A) or (B) of FIG. 7), the setting unit 15 acquires answer information of the student with respect to the question and sets a knowledge level of the student based on the answer information.

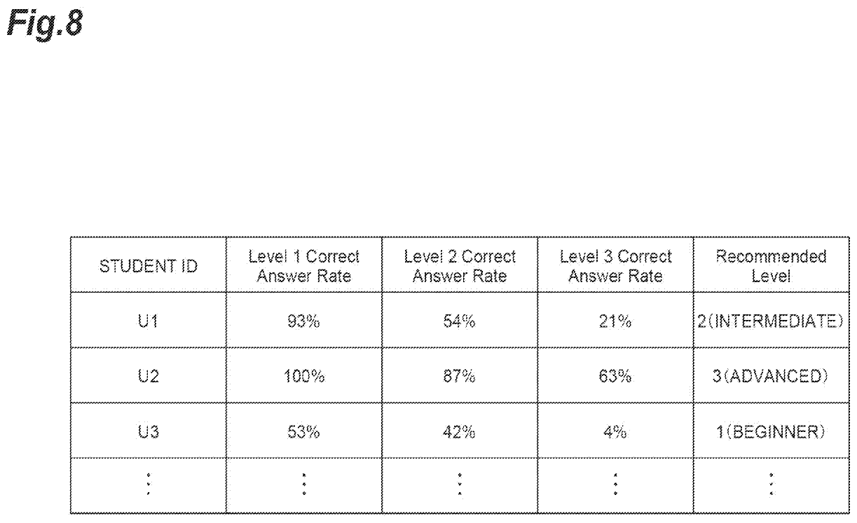

FIG. 8 is a diagram illustrating an example of a knowledge level setting process performed by the setting unit 15. The setting unit 15 compares answer information for the quiz as shown in (A) of FIG. 7 with the correct answer of the quiz held in advance to determine whether or not the student has correctly answered the quiz. Then, the setting unit 15 calculates the latest correct answer rate for each keyword level. In the example of FIG. 8, for the student of the student ID “U1”, the correct answer rate for the quiz related to the keyword of Level 1 is calculated as “93%”, the correct answer rate for the quiz related to the keyword of Level 2 is calculated as “54%”, and the correct answer rate for the quiz related to the keyword of Level 3 is calculated as “21%”. As an example, the setting unit 15 sets a knowledge level corresponding to lowest level of keyword that has a correct answer rate equal to or less than a predetermined threshold (for example, 60%). Here, Level 1 of keyword corresponds to the beginner level, Level 2 of keyword corresponds to the intermediate level, and Level 3 or higher of keyword corresponds to the advanced level.

In the example of FIG. 8, for the student of the student ID “U1”, since the lowest level of keyword whose correct answer rate is equal to or less than the threshold value is “Level 2”, the intermediate level corresponding to “Level 2” is set. For the student of the student ID “U2”, since there is no level of keyword whose correct answer rate is equal to or less than the threshold value (at least Level 3 or more), the advanced level corresponding to “Level 3 or more” is set. For the student of the student ID “U3”, since the lowest level of keyword whose correct answer rate is equal to or less than the threshold value is “Level 1”, the beginner level corresponding to “Level 1” is set.

According to the processing of the setting unit 15 described above, the knowledge level of student can be dynamically set or updated in accordance with the progress of the lecture. The setting unit 15 may set the knowledge level of student based on answer information for a questionnaire (for example, (B) of FIG. 7). In this case, the setting unit may execute the same process as described above by using the rate of the answers “I know” instead of the “correct answer rate” in the example of FIG. 8.

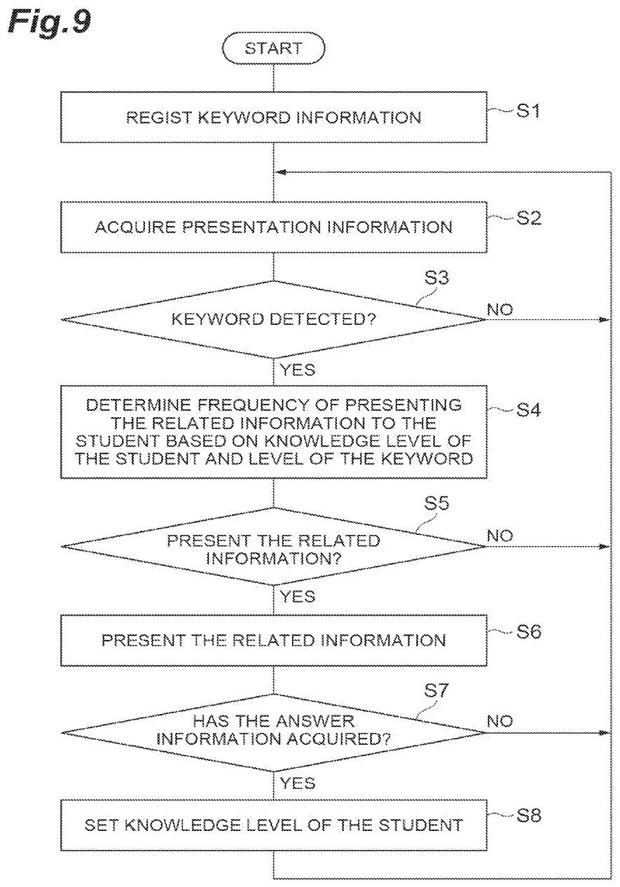

An example of processing of the related information presentation server 10 will be described with reference to a flowchart illustrated in FIG. 9. Step S1 is executed in advance before the start of the lecture. Steps S2 to S8 are repeatedly executed during the lecture until the lecture ends. Further, the processing of steps S4 to S8 is executed for each combination of the detected keyword and student.

First, the keyword manager 11 registers and sets the keyword information (see FIG. 3) in the keyword DB 10a (step S1). Subsequently, the acquisition unit 12 acquires presentation information in accordance with the progress of presentation (online lecture in the present embodiment) by the lecturer (step S2). Subsequently, when a keyword is included in the presentation information, the detection unit 13 detects the keyword (step S3). When a keyword is detected (step S3: YES), the presentation unit 14 determines, for each student, the frequency of presenting the related information based on the level of the keyword and the knowledge level of each student (step S4).

Subsequently, for each combination of a keyword and a student, the presentation unit 14 determines whether or not to present the related information of the keyword in response to the current keyword detection based on the determined frequency (step S5). In the present embodiment, the presentation unit 14 determines to present the related information when the frequency determined in step S4 is the first frequency (presented each time), when the frequency determined in step S4 is the second frequency (reminder presentation) and a certain period of time has elapsed since the latest presentation of the related information of the keyword, and when the frequency determined in step S4 is the third frequency (presented for first time only) and the related information of the keyword has not been presented (step S5: YES). On the other hand, in cases other than the above, the presentation unit 14 determines not to present the related information (step S5: NO).

Subsequently, when it is determined that the related information is presented for a combination of a certain keyword and a certain student (step S5: YES), the presentation unit 14 presents the related information of the keyword to the student (step S6) (see FIG. 5). Subsequently, when the related information includes a question for measuring the understanding of the student about the keyword and the setting unit 15 acquires answer information from the student computer 30 via the online lecture server 40 (step S7: YES), the setting unit 15 sets (updates) the knowledge level of the student based on the answer information (step S8).

In the related information presentation server 10 described above, it is possible to effectively improve the understanding of the student with respect to lecture content by presenting the related information of the keyword included in the lecture content presented by the lecturer to the student. Furthermore, since the frequency of presenting the related information to the student is adjusted based on at least one of the knowledge level of the student and the degree of difficulty of the keyword (both in the present embodiment), it is possible to effectively present the related information to the student at an appropriate frequency in accordance with the student or the keyword. Therefore, the convenience of the student can be further improved.

In the above-described embodiment, a case where the online lecture is performed has been described as an example, but the related information presentation server 10 described above may be used for any presentation other than the online lecture. Further, the system configuration of the online lecture system 1 illustrated in FIG. 1 is an example, and the configuration of the online lecture system including the related information presentation server 10 may be arbitrarily changed. For example, the related information presentation server 10 and the online lecture server 40 may be configured by the same server.

Further, the function of the related information presentation server 10 may be implemented in the lecturer computer 20. Further, the data communication is not limited to the above embodiment. For example, the related information may be transmitted to the online lecture server 40 through the related information presentation client 21 of the lecturer computer 20.

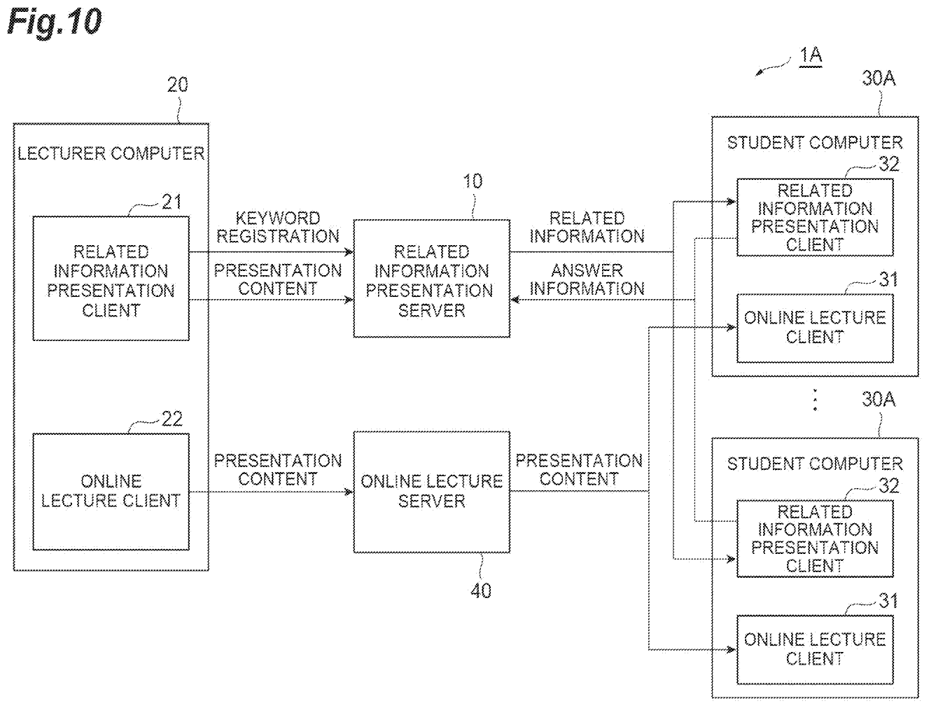

Further, a system that delivers the online lecture and a system that presents the related information (including reception of answer information) may be independent of each other. FIG. 10 is a diagram illustrating an overall configuration of an online lecture system 1A according to a modification. The online lecture system 1A is mainly different from the online lecture system 1 in that it includes a student computer 30A further provided with a related information presentation client 32 instead of the student computer 30. More specifically, the online lecture system 1A is different from the online lecture system 1 in that transmission and reception of the related information and the answer information are performed directly between the related information presentation server 10 and the related information presentation client 32 without via the online lecture server 40. According to the online lecture system 1A, a system for presenting the related information (i.e., a part including the related information presentation server 10 and the related information presentation clients 21 and 32) is added while using a conventional system for distributing the online lecture (i.e., a part including the online lecture server 40 and the online lecture clients 22 and 31) almost as it is, whereby the above-described mechanism (i.e., a mechanism for presenting the related information to students in accordance with the progress of lectures) can be implemented. In the online lecture system 1A, of the lecture screen SC (see FIG. 5) presented to the student, the first display area A1 and the second display area A2 are generated based on the data distributed from the online lecture server 40 to the student computer 30A (the online lecture client 31), and the third display area A3 for presenting the related information is generated based on the data distributed from the related information presentation server to the student computer 30A (the related information presentation client 32).

The types of frequency determined by the presentation unit 14 is not limited to the first frequency to the fourth frequency described above. The types of frequency may be two or three of the first frequency to the fourth frequency, or may include a type other than the first frequency to the fourth frequency.

The block diagrams used in the description of the embodiment show blocks in units of functions. These functional blocks (components) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but not limited thereto.

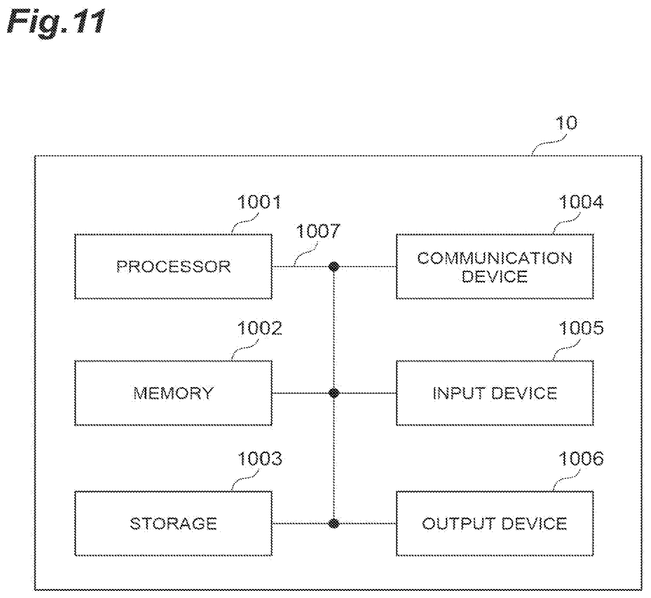

For example, the related information presentation server 10 according to an embodiment of the present invention may function as a computer that performs an information processing method of the present disclosure. FIG. 11 is a diagram illustrating an example of a hardware configuration of the related information presentation server 10 according to the embodiment of the present disclosure. The related information presentation server 10 described above may be physically configured as a computer device including a processor 1001, a memory 1002, a storage 1003, a communication device 1004, an input device 1005, an output device 1006, a bus 1007, and the like.

In the following description, the term “device” can be referred to as a circuit, a device, a unit, or the like. The hardware configuration of the related information presentation server 10 may include one or a plurality of devices illustrated in FIG. 11, or may be configured without including some of the devices.

Each function in the related information presentation server 10 is realized by loading predetermined software (a program) into hardware such as the processor 1001 or the memory 1002 so that the processor 1001 performs computation to control communication that is performed by the communication device 1004 or control at least one of reading and writing of data in the memory 1002 and the storage 1003.

The processor 1001, for example, operates an operating system to control the entire computer. The processor 1001 may be configured as a central processing unit (CPU) including an interface with peripheral devices, a control device, a computation device, a register, and the like.

Further, the processor 1001 reads a program (program code), a software module, data, or the like from at one of the storage 1003 and the communication device 1004 into the memory 1002 and executes various processes according to the program, the software module, the data, or the like. As the program, a program for causing the computer to execute at least some of the operations described in the above-described embodiment may be used. For example, the presentation unit 14 may be realized by a control program that is stored in the memory 1002 and operated on the processor 1001, and other functional blocks may be realized similarly. Although the case in which the various processes described above are executed by one processor 1001 has been described, the processes may be executed simultaneously or sequentially by two or more processors 1001. The processor 1001 may be realized using one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store an executable program (program code), software modules, and the like in order to implement the communication control method according to the embodiment of the present disclosure.

The storage 1003 is a computer-readable recording medium and may also be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including at least one of the memory 1002 and the storage 1003, a server, or another appropriate medium.

The communication device 1004 is hardware (a transmission and reception device) for performing communication between computers via at least one of a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, the respective devices such as the processor 1001 and the memory 1002 are connected by the bus 1007 for information communication. The bus 1007 may be configured using a single bus or may be configured using buses different between the devices.

Further, the related information presentation server 10 may include hardware such as a microprocessor, a digital signal processor (DSP), an application specific integrated circuit (ASIC), a programmable logic device (PLD), or a field programmable gate array (FPGA), and some or all of the functional blocks may be realized by the hardware. For example, the processor 1001 may be implemented by at least one of these pieces of hardware.

Although the present embodiment has been described in detail above, it is apparent to those skilled in the art that the present embodiment is not limited to the embodiments described in the present disclosure. The present embodiment can be implemented as a modification and change aspect without departing from the spirit and scope of the present invention determined by description of the claims. Accordingly, the description of the present disclosure is intended for the purpose of illustration and does not have any restrictive meaning with respect to the present embodiment.

A process procedure, a sequence, a flowchart, and the like in each aspect/embodiment described in the present disclosure may be in a different order unless inconsistency arises. For example, for the method described in the present disclosure, elements of various steps are presented in an exemplified order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to be made explicitly, and may be made implicitly (for example, a notification of the predetermined information is not made).

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless whether the software is called software, firmware, middleware, microcode, or hardware description language or called another name.

Further, software, instructions, information, and the like may be transmitted and received via a transmission medium. For example, when software is transmitted from a website, a server, or another remote source using wired technology (a coaxial cable, an optical fiber cable, a twisted pair, a digital subscriber line (DSL), or the like) and wireless technology (infrared rays, microwaves, or the like), at least one of the wired technology and the wireless technology is included in a definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or an arbitrary combination of them.

Further, the information, parameters, and the like described in the present disclosure may be expressed using an absolute value, may be expressed using a relative value from a predetermined value, or may be expressed using another corresponding information.

Names used for the above-described parameters are not limited names in any way. Further, equations or the like using these parameters may be different from those explicitly disclosed in the present disclosure. Since various information elements can be identified by any suitable names, the various names assigned to these various information elements are not limited names in any way.

The description “based on” used in the present disclosure does not mean “based only on” unless otherwise noted. In other words, the description “based on” means both of “based only on” and “based at least on”.

Any reference to elements using designations such as “first,” “second,” or the like used in the present disclosure does not generally limit the quantity or order of those elements. These designations may be used in the present disclosure as a convenient way for distinguishing between two or more elements. Thus, the reference to the first and second elements does not mean that only two elements can be adopted there or that the first element has to precede the second element in some way.

When “include”, “including” and transformation of them are used in the present disclosure, these terms are intended to be comprehensive like the term “comprising”. Further, the term “or” used in the present disclosure is intended not to be exclusive OR.

In the present disclosure, for example, when articles such as “a”, “an”, and “the” in English are added by translation, the present disclosure may include that nouns following these articles are plural.

In the present disclosure, a sentence “A and B are different” may mean that “A and B are different from each other”. The sentence may mean that “each of A and B is different from C”. Terms such as “separate”, “coupled”, and the like may also be interpreted, similar to “different”.

### REFERENCE SIGNS LIST

10 related information presentation server (information processing device)
11 keyword manager
12 acquisition unit
13 detection unit
14 presentation unit
15 setting unit

1. An information processing device, comprising:
an acquisition unit configured to acquire presentation information indicating presentation content presented by a presenter;
a detection unit configured to detect a pre-registered keyword included in the presentation information acquired by the acquisition unit; and
a presentation unit configured to present related information related to the keyword detected by the detection unit to a viewer,
wherein the presentation unit is configured to:
determine a frequency of presenting the related information to the viewer based on at least one of a knowledge level of the viewer regarding the presentation content and a degree of difficulty of the keyword; and
present the related information to the viewer in accordance with the determined frequency.

2. The information processing device according to claim 1, wherein the presentation unit is configured to determine the frequency so that the frequency is higher as the knowledge level of the viewer is lower.

3. The information processing device according to claim 1, wherein the presentation unit is configured to determine the frequency so that the frequency is higher as the degree of difficulty of the keyword is higher.

4. The information processing device according to claim 1, wherein the presentation unit is configured to determine the frequency based on a combination of a knowledge level of the viewer and a degree of difficulty of the keyword.

5. The information processing device according to claim 1, wherein the type of frequency determined by the presentation unit includes at least two of:
a first frequency indicating that the related information is presented each time the keyword appears;
a second frequency indicating that the related information is not presented even if the keyword appears again within a predetermined period from the last presentation of the related information of the keyword;
a third frequency indicating that the related information is presented only when the keyword first appears; and
a fourth frequency indicating that the related information of the keyword is not presented at all.

6. The information processing device according to claim 1, further comprising a setting unit configured to acquire answer information of the viewer with respect to a question for measuring an understanding of the viewer for the keyword and set the knowledge level of the viewer based on the answer information, wherein
the related information includes the question for measuring an understanding of the viewer about the keyword.

7. The information processing device according to claim 1, further comprising a keyword manager configured to calculate importance of the keyword based on a term frequency of the keyword in a document used for presentation by the presenter and an inverse document frequency of the keyword in a plurality of documents related to a field to which the keyword belongs, and set a degree of difficulty of the keyword based on the importance.
